(19) United States
(12) Patent Application Publication
(10) Pub. No.: US 2020/0238499 A1
(43) Pub. Date: Jul. 30, 2020

(54) Drum Speed Key Tool

(71) Applicant: Stephen Austin Fuller, Denton, TX (US)

(72) Inventor: Stephen Austin Fuller, Denton, TX (US)

(21) Appl. No.: 16/751,914

(22) Filed: Jan. 24, 2020

Related U.S. Application Data
(60) Provisional application No. 62/796,905, filed on Jan. 25, 2019.

(51) Int. Cl. B25G 1/00; B25B 13/48; G10D 13/16

(52) U.S. Cl. CPC B25G 1/005; G10D 13/16; B25B 13/48

(57) ABSTRACT

A novel drum speed key tool that provides improved balance and efficiency for the installation, tightening, and removal of drum lug nuts. The drum speed key tool provides a finger receiving cup to allow a user to insert a finger or grip with their hand and efficiently apply rotational force to the drum speed key while maintaining attached to the drum lug nut with reduced slippage of the drum speed key tool from both the user's grip and the drum lug nut.

This application claims benefit to the priority date of U.S. Provisional Application No. 62/796,905, filed on Jan. 25, 2019.

### TECHNICAL FIELD

The novel invention described herein concerns various improvements to tools used for installing, tightening, and removal of drum lugs both in a quick and efficient manner. The invention allows for reduced slippage from both the user's hand and the drum lug itself. The type of tool referenced herein is referred to as a “drum key.”

### BACKGROUND

FIG. 1 Prior versions of drum keys consist of “L” shaped tools 10 wherein the socket head 11 is affixed to a first end 12 of a lateral member 15 and the handle 13 being affixed to the second end 14 of the lateral member 15. When prior versions of drum keys are oriented in a position where the handle is superior to the socket head, the socket head is posed on the underside of the lateral member while the handle is posed on the upperside of the later member. The axis of rotation 17 when the socket head is mated with a drum lug is directly in line with the lug. The offset handle of the “L” shaped key is unbalanced causing it to the wobble or fall off the drum lug when rotational force is applied to the key. The “L” shaped key is not sturdy or balanced enough to be efficiently operated with one hand, but instead commonly requires two hands to be optimally operated and stay affixed to the drum lug during rotation.

Other prior drum keys may take the form of a “T-handle” tool 20. FIG. 1 The T-handle drum key may be made of one or more pieces, but requires the user to grip a perpendicular member 21 to apply rotational force to the member 22 affixed to the socket head 23. Prior drum keys are typically made of a single piece of metal or plastic. FIG. 1 provides depictions of prior drum keys.

### SUMMARY OF INVENTION

The novel drum speed key tool described herein allows for a drum user to quickly and efficiently tighten drum lugs and improves upon earlier versions of drum keys found in the marketplace. The improvements described herein comprise improvements to the gripping handle of a drum key by replacing the typical rod with a receiving cup. The receiving cup allows a user to preferably insert his or her finger into the receiving cup and then proceed to spin the drum speed key allowing quick and efficient tightening of the drum lugs. The user's finger then becomes the driving force without the need for re-adjustment of the user's grip on the tool during tuning operations.

### BRIEF DESCRIPTION OF DRAWINGS

FIG. 1 is a depiction of prior versions of drum key.

FIG. 2 is an exploded depiction of the drum speed key tool.

FIG. 3 is an isometric depiction of an alternative embodiment of the drum speed key tool.

FIG. 4 is a side profile depiction of a preferred embodiment of the drum speed key tool.

FIG. 5 provides an alternative view of the preferred embodiment of the drum speed key tool.

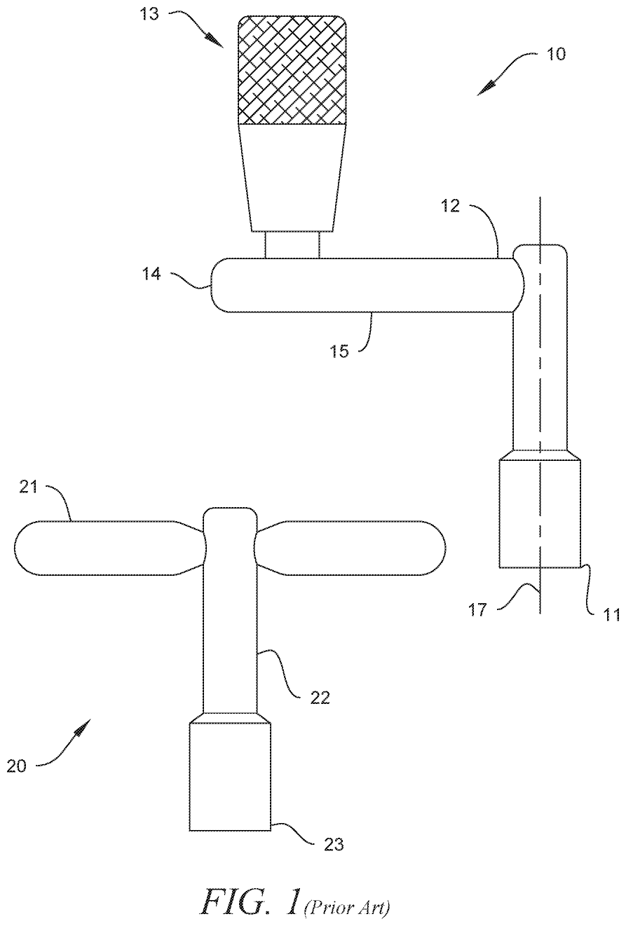

### DESCRIPTION OF EMBODIMENTS

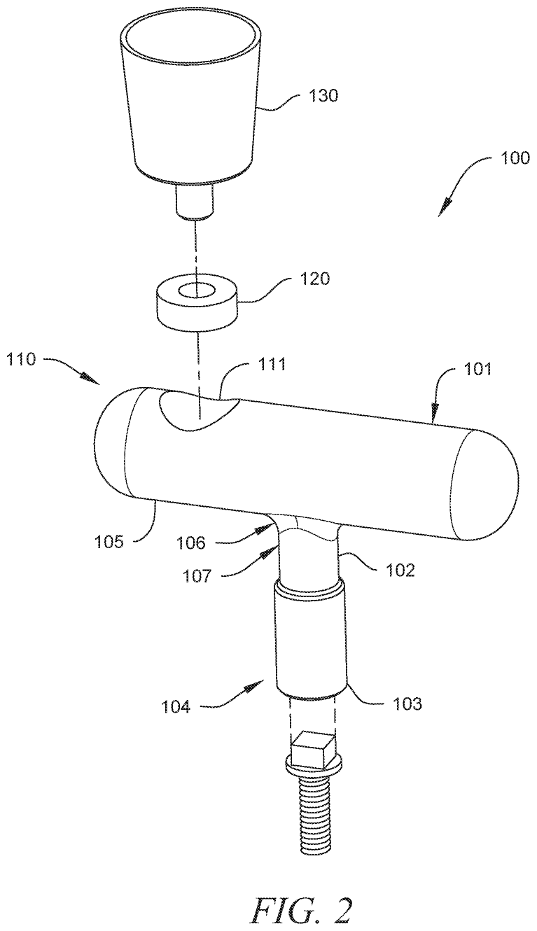

FIG. 2 depicts a preferred embodiment of the drum speed key tool and is described as follows. The drum speed key tool 100 preferably comprises a T-handle shape 101 made from perpendicular members. The first member 102 has a socket 103 at a first end 104 and is affixed or joined to a cross member's 105 medial point 106 at a second end 107 of the first member forming a “T” shape. At a first end 110 of the cross member 105 there is preferably formed a cavity 111 for receiving a bearing 120 on the superior side of the cross member. A bearing 120 is then seated within cavity 111 and the finger receiving cup 130 is then pressed into the bearing 120 allowing rotation of the finger receiving cup 130. Alternatively, the first member and cross member can be oriented in various configurations including an “L” shaped configuration wherein the finger receiving cup is positioned at a first end of the cross member and the first member is positioned at the second end of the cross member.

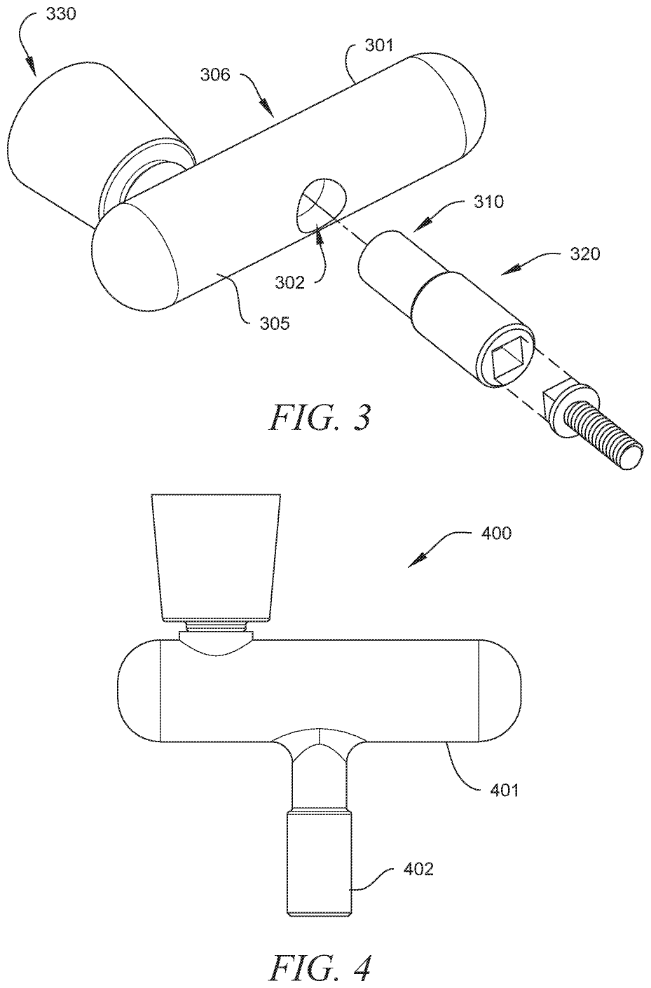

The drum speed key tool 100 can be made through the process of milling or forging the finger receiver cup 130. Preparation of the cross member 105 begins by cutting a bearing hole 111 and pressing the bearing 120 into the made bearing hole 111. With reference to FIG. 3, the cross member 301 can then have a receiving hole cut 302 or formed on the bottom surface 305 of the cross member to receive a connecting end 310 of the lug receiving member 320. The lug receiving member connecting end 310 is then joined to the cross member 301. The finger receiving cup 330 is then pressed into the bearing situated on the top surface 306 of the cross member. FIG. 4. Alternatively, the “T” shaped drum speed key 400 comprising a cross member 401 and a lug receiving member 402 can be made from a single piece of metal or high-density polymer rather than joining the two members together. It should be appreciated that the steps described herein can be performed in various orders or configurations to achieve the same final assembled tool.

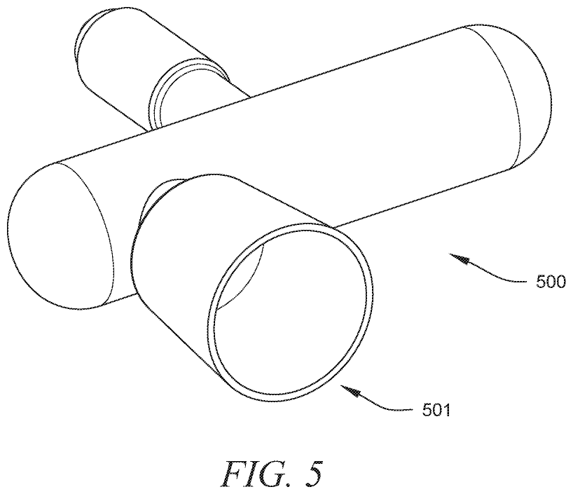

The drum speed key tool disclosed herein is preferably made of aluminum for strength and weight considerations, but other materials for the components may be substituted such as stainless steel or high-density polymer. As an exemplary embodiment, the square lug receiver end should have an internal measurement of 5.461 mm (0.215 inches) across for standard drum lugs. The outside measurement of the lug receiver end can be 15.05 mm (0.5925 inches). It should be appreciated that these measurements described herein may be varied to appropriate mate with the lugs to be used in conjunction with the drum speed key tool. FIG. 5 The overall size of the drum speed key tool 500 and size of the components, such as the finger receiving cup 501, can be varied to allow options for users to select and use the most appropriate size tool for their particular application or capabilities. Some users may have larger fingers or hands than other users and thus may require a larger finger receiving cup for proper operation of the drum speed key tool.

1. An apparatus for rotating a drum lug nut comprising:
a first cross member having a receiving socket formed at a distal end and a receiving portion formed at a medial point of the first cross member;
a second member having a first lug nut receiving end and a joining end;
the second member joining end for attachment to the receiving portion formed at the medial point of the first cross member; and
a receiving cup affixed to the distal end of the first cross member.

2. The apparatus of claim 1 wherein the first cross member has a cavity formed thereon approximate to the distal end of the first cross member.

3. The apparatus of claim 2 wherein a bearing is inserted into the cavity.

4. The apparatus of claim 3 wherein the receiving cup is insertable into the bearing installed in the cavity formed at the distal end of the first cross member.

5. The apparatus of claim 4 wherein the first lug nut receiving end comprises a lug nut receiving cavity having an inner dimension of 0.215 inches across.

6. An apparatus for rotating a drum lug nut comprising:
a T-shaped member comprising a cross member portion and a receiving socket portion, wherein the receiving socket portion extends from a medial point of the cross member portion; wherein the cross member portion has a cavity formed thereon approximate to a distal end of the cross member portion;
the receiving socket portion having a first lug nut receiving end; and
a receiving cup affixed to the distal end of the first cross member.

7. The apparatus of claim 6 further comprising:
a bearing inserted into the cavity formed on the cross member portion.

8. The apparatus of claim 7 further comprising:
a receiving cup being insertable into the bearing installed in the cavity formed on the cross member portion.

9. The apparatus of claim 8 wherein the T-shaped member is comprised of a metal.

10. The apparatus of claim 8 wherein the T-shaped member is comprised of a high-density plastic polymer.

11. An apparatus for rotating a drum lug nut comprising:
a first cross member having a receiving socket formed at a distal end and a receiving portion formed at a proximate end of the first cross member;
a second member having a first lug nut receiving end and a joining end;
the second member joining end for attachment to the receiving portion formed at the proximate end point of the first cross member; and
a receiving cup affixed to the distal end of the first cross member.

12. The apparatus of claim 11 wherein the first cross member has a cavity formed thereon approximate to the distal end of the first cross member.

13. The apparatus of claim 12 wherein a bearing is inserted into the cavity.

14. The apparatus of claim 13 wherein the receiving cup is insertable into the bearing installed in the cavity formed at the distal end of the first cross member.

15. The apparatus of claim 14 wherein the first lug nut receiving end comprises a lug nut receiving cavity having an inner dimension of 0.215 inches across.
